(19) United States
(12) Patent Application Publication
(10) Pub. No.: US 2026/0019754 A1
(43) Pub. Date: Jan. 15, 2026

(54) VIBRATION SYSTEM, VIBRATION COMPONENT, AND MOBILE BODY

(71) Applicant: Panasonic Automotive Systems Co., Ltd., Kanagawa (JP)

(72) Inventor: Yuki KOBAYASHI, Osaka (JP)

(73) Assignee: Panasonic Automotive Systems Co., Ltd., Kanagawa (JP)

(21) Appl. No.: 19/245,959

(22) Filed: Jun. 23, 2025

(30) Foreign Application Priority Data
Jul. 9, 2024 (JP) 2024-110258

(51) Int. Cl. H04R 9/06

(52) U.S. Cl. CPC H04R 9/066; H04R 2400/07; H04R 2440/05; H04R 2499/13

(57) ABSTRACT

A vibration system includes: a vibration component; and an exciter attached to the vibration component. The exciter includes a fixing portion that fixes the exciter to the vibration component. The vibration component includes an affixing portion to which the fixing portion is attached, and which is more readily elastically deformable than other parts of the vibration component.

### CROSS REFERENCE TO RELATED APPLICATION

The present application is based on and claims priority of Japanese Patent Application No. 2024-110258 filed on Jul. 9, 2024.

### FIELD

The present disclosure relates to a vibration system and a vibration component capable of imparting vibration to an operator, and to a mobile body including the vibration system.

### BACKGROUND ART

Conventionally, there is a technique, such as that described in Patent Literature (PTL) 1, in which an exciter is attached to a plate-like vibration component such a car interior material or a building interior material, to make the entire vibration component function like a speaker.

### CITATION LIST

### Patent Literature

PTL 1: Japanese Unexamined Patent Application Publication No. 2007-318623

### SUMMARY

However, the exciter described in aforementioned PTL 1 can be improved upon.

In view of this, the present disclosure provides a vibration system, a vibration component, and a mobile body that are capable of improving upon the related art.

A vibration system according to an aspect of the present disclosure includes: a vibration component; and an exciter attached to the vibration component. The exciter includes a fixing portion that fixes the exciter to the vibration component, and the vibration component includes an affixing portion to which the fixing portion is attached, the affixing portion being more readily elastically deformable than other parts of the vibration component.

A vibration component according to an aspect of the present disclosure is a vibration component to be attached to an exciter, and includes: an affixing portion to which the exciter is to be attached, the affixing portion being more readily elastically deformable than other parts of the vibration component.

A mobile body according to an aspect of the present disclosure includes: a vibration system including: a vibration component; and an exciter attached to the vibration component. The exciter includes a fixing portion that fixes the exciter to the vibration component. The vibration component includes an affixing portion to which the fixing portion is attached, the affixing portion being more readily elastically deformable than other parts of the vibration component. The vibration system causes the exciter to vibrate based on an inputted electrical signal to cause the vibration component to vibrate.

The present disclosure can improve upon the related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a perspective view of an operating component that includes a vibration system.

FIG. 2 is a perspective view of the vibration system in a disassembled state.

FIG. 3 is a cross-sectional view of the internal structure of a magnetic exciter.

FIG. 4 is a perspective view of Other Example 1 of a vibration system in a disassembled state.

FIG. 5 is a perspective view of Other Example 2 of a vibration system in a disassembled state.

FIG. 6 is a diagram illustrating a mobile body including the vibration system.

### DESCRIPTION OF EMBODIMENTS

Hereinafter, embodiments of a vibration system, a vibration component, and a mobile body according to the present disclosure will be described with reference to the drawings. It should be noted that each of the subsequent embodiments shows an example for describing the present disclosure, and thus is not intended to limit the present disclosure. For example, the shapes, structures, materials, structural components, the relative positional relationships and connections of the structural components, numerical values, formulas, steps of a method, the processing order of the steps, and so on, shown in the following embodiments are mere examples, and details not described below may be included. Furthermore, although there are cases where geometric expressions, such as “parallel” and “orthogonal”, are used, these expressions are not mathematically precise indications and include substantially permissible error, deviation, and the Moreover, expressions such as “simultaneous” and like. “identical (or the same)” are considered to cover a substantially permissible range of meaning.

Additionally, the drawings are schematic illustrations that may include emphasis, omission, or adjustment of proportion as necessary for the purpose of describing the present disclosure, and thus the shapes, positional relationships, and proportions shown may be different from actuality. Furthermore, the X-axis, Y-axis, and Z-axis which may be shown in the drawings are arbitrarily set rectangular coordinates for describing the figures. In other words, the Z-axis is not limited to an axis in the vertical direction, and the X-axis and Y-axis are not limited to being axes inside a horizontal plane.

Furthermore, hereinafter, multiple inventions may be comprehensively described as a single embodiment. Moreover, part of the contents in the description below is described as an optional element related to the present disclosure.

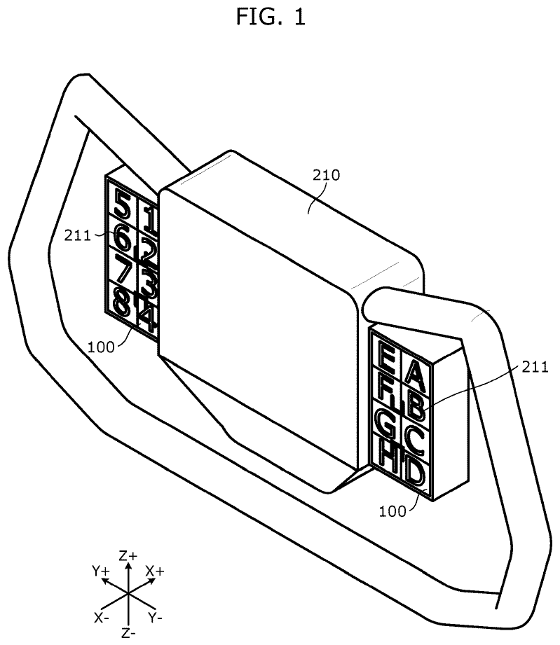

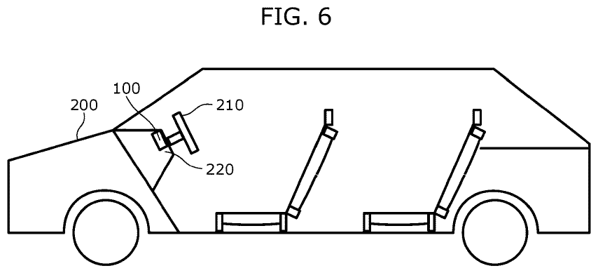

FIG. 1 is a perspective view of operating component 210 that includes vibration system 100. Operating component 210 is a component for operating mobile body 200 (see FIG. 6) such as a car, a bus, a truck, an aircraft, a ship, a train, a construction machine, an agricultural machine, and so on. Operating component 210 is a component on which an operator performs an operation, and includes receiving components 211. Receiving components 211 receive input related to the operation of mobile body 200 from the operator, input regarding navigation or audio from the operator, and so on. Vibration system 100 is disposed at the back (in the figures, the X+ side) of receiving component 211, and generates vibration when receiving component 211 receives an input from the operator. It should be noted that the vibration may be vibration of a frequency that can be heard as sound by the operator.

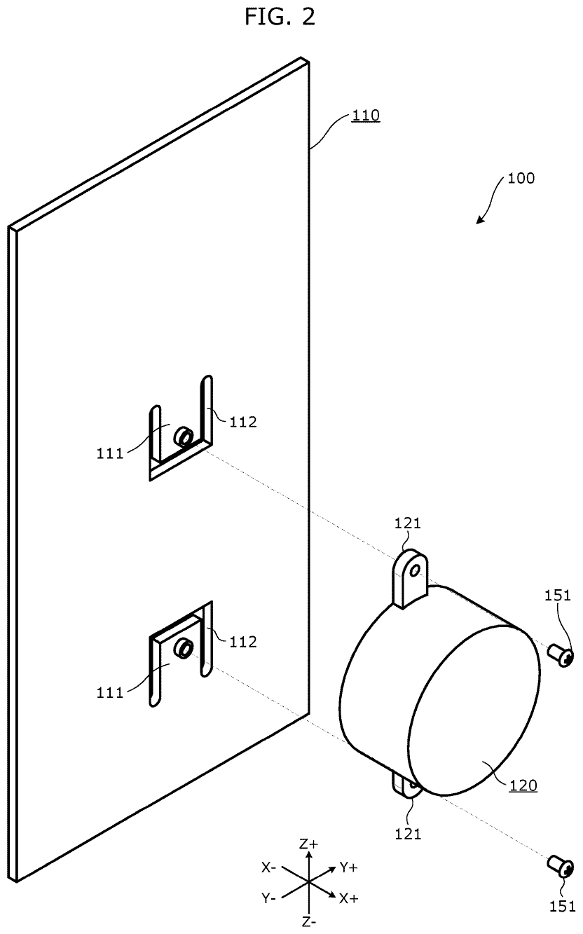

FIG. 2 is a perspective view of vibration system 100 in a disassembled state. Vibration system 100 is a system that generates vibration (including sound) based on an inputted electrical signal, and includes vibration component 110, and exciter 120.

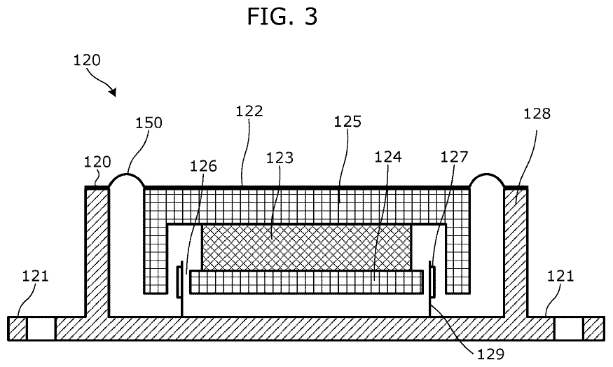

Exciter 120 includes fixing portions 121 that fix exciter 120 to vibration component 110. Exciter 120 causes vibration component 110 via fixing portions 121, based on the inputted electrical signal. Exciter 120 is a so-called actuator (exciter) that causes vibration component 110 to vibrate. Exciter 120 is not limited in type, and may be exemplified by an exciter composed of a magnet and a coil, an exciter that uses a piezoelectric element, an exciter that uses a magnetostrictor, or the like. In the present embodiment, exciter 120 is a magnetic actuator that includes magnetic circuit 122, frame 128, and suspension 150. FIG. 3 is a cross-sectional view of the internal structure of exciter 120 that is of the magnetic type.

Magnetic circuit 122 includes columnar magnet 123 that is a magnetized permanent magnet, disc-shaped top plate 124 that is attached to an end surface of magnet 123 in such a manner that the periphery of top plate 124 protrudes beyond magnet 123, and bottomed, cylindrical bottom plate 125 that is attached to the end surface of magnet 123 that is on the opposite side from top plate 124. Bottom plate 125 coaxially houses magnet 123 and top plate 124, and annular magnetic gap 126 is formed between top plate 124 and bottom plate 125. Coil 127 is disposed in magnetic gap 126.

Frame 128 is a structural component that holds magnetic circuit 122 and coil 127. Although frame 128 is not limited to a particular shape, in the present embodiment, frame 128 is in the shape of a bottomed cylinder in an overall view. The outer circumferential edge of bottom plate 125 of magnetic circuit 122 is disposed at a position that is surrounded by the edge portion of the open end of frame 128. Frame 128 and bottom plate 125 are bonded by adhesive via annular suspension 150 so as to be disposed coaxially.

An electrical signal indicating vibration (sound) is inputted to coil 127. Interaction between the magnetic force generated in coil 127 and the magnetic force present in magnetic gap 126 causes a force corresponding to the electrical signal to be generated in the winding axis direction of coil 127. In this embodiment, coil 127 is wound around the outer circumference of cylindrical bobbin 129, and is attached to the center portion of frame 128 via bobbin 129.

With the above-described configuration, exciter 120 causes magnetic circuit 122 and frame 128 to relatively reciprocate in the winding axis direction of coil 127 based on the force generated in coil 127, to generate vibration. Exciter 120 can impart vibration corresponding to the electrical signal to vibration component 110 which is joined to frame 128.

Although the case of an inner magnet type magnetic circuit 122 has been described as a structure of exciter 120, magnetic circuit 122 included in exciter 120 is not limited to this type, and may be of the outer magnet type.

Fixing portions 121 are parts for attaching exciter 120 to vibration component 110. Fixing portions 121 are provided so as to protrude from frame 128 of exciter 120. In the present embodiment, exciter 120 includes a plurality of fixing portions 121 that are arranged radially about the winding axis of coil 127. The joining method of exciter 120 and vibration component 110 is not limited and, in the present embodiment, fixing portions 121 and vibration component 110 are fixed by way of fastening components 151 (see FIG. 2).

Vibration component 110 is a component to which vibration generated by exciter 120 is communicated so as to vibrate as a whole. Vibration component 110 may have only the function of vibrating, or may have other functions at the same time. For example, as previously described, vibration component 110 is disposed at the back of receiving component 211, and may also have a function of supporting receiving component 211, a function of holding wiring for receiving component 211, and so on.

The material and shape of vibration component 110 is not limited, and as long as the material constituting vibration component 110 is light and rigid, vibration can be effectively propagated to other components. For example, as a material forming vibration component 110, hard aluminum is preferable over soft aluminum. It should be noted that the material forming vibration component 110 may be another metal or a metal alloy, and may even be a resin, and so on.

Vibration component 110 is provided with affixing portions 111 to which fixing portions 121 are fixed. Here, affixing portions 111 are more readily capable of elastic deformation than other parts of vibration component 110. The shape of affixing portions 111 is not limited but is preferable a shape that allows affixing portions 111 to resonate at the single resonance frequency of the attached exciter 120. In the present embodiment, each of affixing portions 111 is surrounded on three sides by slit 112 which penetrates in the thickness direction (in the figures, the X-axis direction) of vibration component 110, so that affixing portion 111 is in the shape of a rectangular tongue. By designing in advance the size of the part of affixing portion 111 that is connected to another part of vibration component 110, the size of affixing portion 111 as a whole, and so on, affixing portions 111 having a natural resonance frequency corresponding to the frequency generated by exciter 120 can be provided to vibration component 110.

It should be noted that the present disclosure is not limited to the above-described embodiments. For example, other embodiments that can be realized by arbitrarily combining structural elements or removing some structural elements described in the present Specification may be embodiments of the present disclosure. Furthermore, variations obtainable through various modifications to the above-described embodiments that can be conceived by a person of ordinary skill in the art without departing from the essence of the present disclosure, that is, the meaning of the recitations in the Claims are included in the present disclosure.

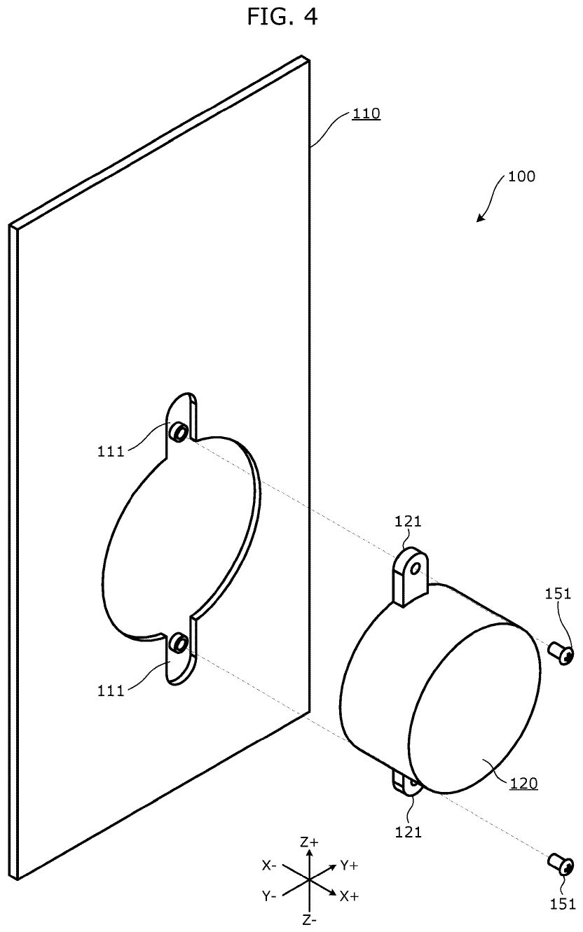

For example, as illustrated in FIG. 4, affixing portions 111 may be portions whose thickness is less than the other parts of vibration component 110.

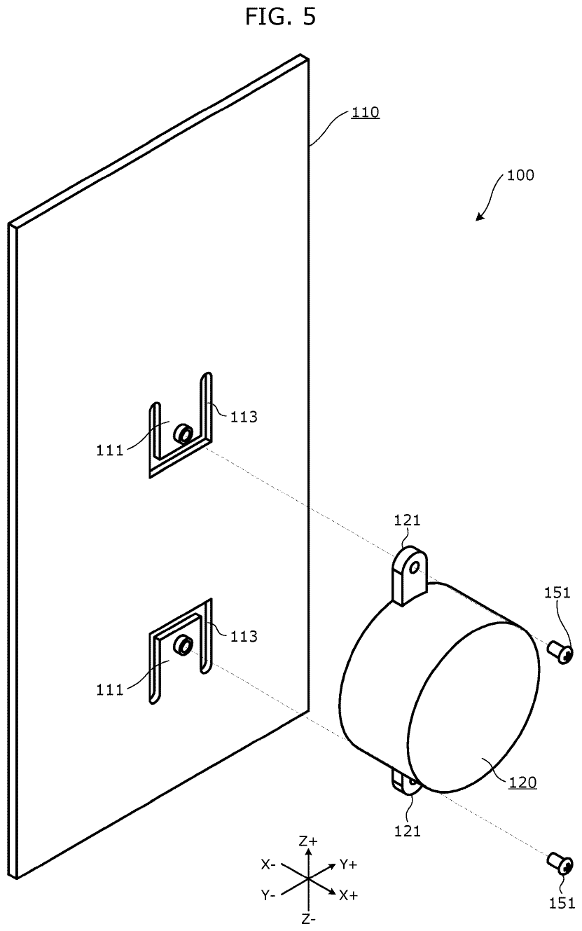

Furthermore, as illustrated in FIG. 5, vibration component 110 may include, at peripheral edges of each of affixing portions 111, trench 113 for facilitating elastic deformation of affixing portion 111.

Furthermore, slit 112 or trench 113 provided at peripheral edges of each of affixing portions 111 is not limited to surrounding affixing portion 111 on three sides of affixing portion 111, and may surround affixing portion 111 on two sides.

Furthermore, slit 112 or trench 113 provided at peripheral edges of each of affixing portions 111 may be curved.

Furthermore, vibration system 100 may be provided to other parts of mobile body 200 such as dashboard 220, and not just to operation component 210.

### CONCLUSION

Vibration system 100 according to a first aspect includes: vibration component 110 and exciter 120 attached to vibration component 110. Exciter 120 includes fixing portion 121 that fixes exciter 120 to vibration component 110, and vibration component 110 includes affixing portion 111 to which fixing portion 121 is attached, and which is more readily elastically deformable than other parts of vibration component 110.

According to the first aspect, vibration component 110 is made light and rigid to enable vibration to effectively propagate to other components, and thus the vibration of exciter 120 can be effectively communicated to the entirety of vibration component 110 via elastically deformable affixing portion 111.

Vibration system 100 according to a second aspect is the vibration system according to the first aspect, in which affixing portion 111 has a thickness less than a thickness of the other parts of vibration component 110.

According to the second aspect, affixing portion 111 that is more elastically deformable than the other parts of vibration component 110 can be formed. Furthermore, it is possible to make affixing portion 111 not visible from one surface of vibration component 110.

Vibration system 100 according to a third aspect is the vibration system according to the first aspect or the second aspect, in which vibration component 110 further includes, at peripheral edges of affixing portion 111, trench 113, or slit 112, for facilitating elastic deformation of affixing portion 111.

According to the third aspect, affixing portion 111 that is more elastically deformable than the other parts of vibration component 110 can be formed. Furthermore, when trench 113 is adopted, it is possible to make affixing portion 111 not visible from one surface of vibration component 110. When slit 112 is adopted, affixing portion 111 can be formed easily in vibration component 110.

Vibration system 100 according to a fourth aspect is the vibration system according to the third aspect, in which trench 113 or slit 112 is arranged to surround affixing portion 111 on three sides of affixing portion 111.

According to the fourth aspect, affixing portion 111 that elastically deforms more readily than the other parts of vibration component 110 can be formed easily in vibration component 110.

Vibration system 100 according to a fifth aspect is the vibration system according to any one of the first to fourth aspects, in which trench affixing portion 111 has a natural resonance frequency corresponding to a frequency generated by exciter 120.

According to the fifth aspect, the vibration of exciter 120 can be communicated efficiently to vibration component 110 via affixing portion 111.

Vibration component 110 according to a sixth aspect is a vibration component to be attached to exciter 120, and includes: affixing portion 111 to which exciter 120 is to be attached, and which is more readily elastically deformable than other parts of vibration component 110.

According to the sixth aspect, vibration component 110 is made to be light and rigid to enable vibration to effectively propagate to other components, and thus the vibration of exciter 120 can be effectively communicated to the entirety of vibration component 110 via elastically deformable affixing portion 111.

Mobile body 200 according to a seventh aspect includes vibration system 100 including: vibration component 110; and exciter 120 attached to vibration component 110. Exciter 120 includes: fixing portion 121 that fixes exciter 120 to vibration component 110. Vibration component 110 includes: affixing portion 111 to which fixing portion 121 is attached, and which is more readily elastically deformable than other parts of vibration component 110. Vibration system 100 causes exciter 120 to vibrate based on an inputted electrical signal to thereby cause vibration component 110 to vibrate.

Further Information about Technical Background to this Application

The disclosure of the following patent application including specification, drawings, and claims is incorporated herein by reference in its entirety: Japanese Patent Application No. 2024-110258 filed on Jul. 9, 2024.

### INDUSTRIAL APPLICABILITY

The present can be used in a vibration system that is to be attached to a household appliance, an information device, home equipment, a mobile body, and so on.

1. A vibration system comprising:
a vibration component; and
an exciter attached to the vibration component, wherein
the exciter includes:
a fixing portion that fixes the exciter to the vibration component, and
the vibration component includes:
an affixing portion to which the fixing portion is attached, the affixing portion being more readily elastically deformable than other parts of the vibration component.

2. The vibration system according to claim 1, wherein
the affixing portion has a thickness less than a thickness of the other parts of the vibration component.

3. The vibration system according to claim 1, wherein
the vibration component further includes:
a trench or a slit disposed at peripheral edges of the affixing portion, the trench or the slit facilitating elastic deformation of the affixing portion.

4. The vibration system according to claim 3, wherein
the trench or the slit is arranged to surround the affixing portion on three sides of the affixing portion.

5. The vibration system according to claim 1, wherein
the affixing portion has a natural resonance frequency corresponding to a frequency generated by the exciter.

6. A vibration component to be attached to an exciter, the vibration component comprising:
an affixing portion to which the exciter is to be attached, the affixing portion being more readily elastically deformable than other parts of the vibration component.

7. A mobile body comprising:
a vibration system including:
a vibration component; and
an exciter attached to the vibration component, wherein
the exciter includes:
a fixing portion that fixes the exciter to the vibration component,
the vibration component includes:
an affixing portion to which the fixing portion is attached, the affixing portion being more readily elastically deformable than other parts of the vibration component, and
the vibration system causes the exciter to vibrate based on an inputted electrical signal to cause the vibration component to vibrate.
